(19) United States
(12) Patent Application Publication
(10) Pub. No.: US 2004/0071871 A1
(43) Pub. Date: Apr. 15, 2004

(54) Use of an amphiphilic block copolymers as adhesion promoters of film-forming aqueous compositions on a low-energy surface

(76) Inventors: Lionel Queval, Salaise-Sur-Sanne (FR); Cecile Bonnet-Gonnet, Paris (FR); Mathias Destarac, Paris (FR)

Correspondence Address: BURNS DOANE SWECKER & MATHIS L L P, POST OFFICE BOX 1404, ALEXANDRIA, VA, 22313-1404, US

(21) Appl. No.: 10/468,825

(22) PCT Filed: Feb. 18, 2002
(86) PCT No.: PCT/FR02/00615

(51) Int. Cl. C08L 53/00

(52) U.S. Cl. 427/207.1; 156/327

(57) ABSTRACT

The invention concerns the use of amphiphilic block copolymer, comprising at least a hydrophilic block and at least a hydrophobic block, as additive for film-forming aqueous compositions such as, in particular, paint, latex or sealant optionally containing silicone to provide or promote adhesion to said compositions on a low-energy surface such as a plastic or thermoplastic polymer surface. The invention also concerns the film-forming aqueous compositions comprising said amphiphilic block copolymers.

The present invention relates to the use of an amphiphilic block copolymer, comprising at least one hydrophilic block and at least one hydrophobic block, as additives for aqueous film-forming compositions, such as in particular paint, latex or mastic compositions, which may or may not comprise silicone, for providing or promoting the adhesion of these compositions to a low-energy surface, such as a surface based on a plastic or thermoplastic polymer.

The invention also relates to the aqueous film-forming compositions comprising these amphiphilic block copolymers.

The term “low-energy surface” within the meaning of the invention is to be understood as materials exhibiting a low affinity for water which is reflected by a low, indeed even zero, wettability.

This wettability is evaluated by the measurement of the contact angle of a drop of water deposited on the surface of the material. This contact angle, generally known as a angle, corresponds to the angle which exists between the surface and the tangent to the drop at the surface/water/air interface and can be measured in particular using a conventional contact angle measuring device, such as, for example, the SDT-200 sold by IT Concept, used in static mode.

The sheets must be perfectly clean, that is to say rubbed beforehand with ethanol. Furthermore, they are reconditioned, that is to say maintained for 24 hours in a climate-controlled chamber under specific temperature and humidity conditions (22° C., 55% relative humidity).

This angle can be between 0 and 180°.

If the angle is zero, then the wetting is 100%.

The liquid spreads completely over the surface and there therefore exists strong interactions between the support and the liquid.

If the angle is 180°, then the wetting is zero.

The liquid forms a bead. There is only one point of contact between the liquid and the support and in particular no affinity.

For intermediate angles, the wetting is partial.

Thus, it is considered that, when this contact angle is greater than 45°, then the material has a low-energy surface.

Generally, low-energy materials have a hydrophobic nature. The term “surface of “hydrophobic” nature” within the meaning of the invention is to be understood as a surface characterized by a contact angle of a drop of water of greater than or equal to 45° and generally of greater than 70°. The term “hydrophilic” is, for its part, employed to denote a surface characterized by a contact angle of a drop of water of less than 45°, preferably of less than or equal to 30°.

Mention may be made, as example of materials having a low-energy surface, of plastic or thermoplastic polymers, such as polyamides, polycarbonates, poly(ethylene terephthalate)s, poly(methyl methacrylate), polypropylenes, polyethylenes, polystyrenes, polyesters, acrylonitrile-butadiene-styrene (ABS) or poly(vinyl chloride)s.

The values measured for the α angle for these materials are combined, by way of illustration, in table I of example 4.

Thus, when an aqueous film-forming composition of paint type or mastic type which may or may not comprise silicone is applied directly to the surface of one of these materials, very poor wetting of the surface by the aqueous composition is observed, which renders impossible the application of this composition or else results, in the best cases, in the production of a coating of mediocre quality.

Furthermore, the adhesive properties of the coatings thus obtained deteriorate in the presence of moisture or on contact of these surfaces with water, in particular because of phenomena of diffusion of water to the interface.

For all these reasons, the deposition of an aqueous film-forming composition of paint type or mastic type which may or may not comprise silicone on a support with a low surface energy, of plastic or thermoplastic polymer type, generally cannot be envisaged industrially.

In point of fact, the Applicant Company has discovered that certain amphiphilic block copolymers can be used as additives in an aqueous film-forming composition to provide or promote the adhesion of these compositions to low-energy surfaces.

The modifications in adhesive properties of aqueous film-forming compositions induced by the presence of these block copolymers make it possible to alleviate the problems encountered to date and it is possible to obtain an improvement in the effectiveness of the application of an aqueous film-forming composition of paint or mastic type but also an improvement in the adhesion to the support of this aqueous film-forming composition which is effective and lasting, even in the presence of water.

This improvement in the adhesion of the coating is reflected by a prolonged decorative, protective or functional effect, advantageously throughout the lifetime of the product, without the effect induced by the coating produced being capable of being threatened by washing with an aqueous solution (S) with a pH of between 1 and 12, optionally comprising sodium chloride, in a proportion of a maximum concentration of 10M, peeling or disintegration of said coating, in particular under the effect of mechanical stresses.

More generally, the presence of these block copolymers of the invention in aqueous film-forming compositions provides these compositions with an affinity with respect to the low-energy surface such that this deposited layer remains firmly attached to the treated surface for relative humidities ranging from 0 to 100%. Advantageously, the deposited layer remains firmly attached in the presence of water, indeed even under immersion in water, including on surfaces of very low energy and/or which are strongly hydrophobic, such as, for example, surfaces based on polypropylene or a polyethylene.

Due to the modification in the surface properties which they bring about, and taking into account their behavior toward water, coatings based on aqueous film-forming compositions comprising the block copolymers produced according to the invention can be employed in numerous fields of application.

Thus, according to a first aspect, a subject matter of the present invention is the use of an amphiphilic block copolymer comprising at least one block of hydrophobic nature (H) and at least one block of hydrophilic nature (h), the block of hydrophobic nature exhibiting hydrophilic units in an amount of between 0% and 95% by weight and preferably between 0.1 and 90% by weight with respect to the total weight of the units of the hydrophobic block, said copolymer optionally being dissolved in a solvent, such as an organic solvent, water or a water/alcohol mixture, as additive in an aqueous film-forming composition, for providing or promoting the adhesion of said composition to a low-energy surface.

Another subject matter of the present invention is an aqueous film-forming composition comprising said amphiphilic block copolymer.

The application of this aqueous film-forming composition according to the invention to the low-energy surface can be carried out by applying this composition to the low-energy surface or else by immersing the surface to be treated in the composition, and then by subsequently removing, at least partially and preferably largely, the solvent initially present in this composition, for example by drying.

The term “partial removal” is to be understood as the removal of at least 70% by mass of the solvent initially present, preferably of at least 80% by mass and more advantageously still of at least 90% by mass. Removal “largely” of the solvent corresponds, for its part, to the removal of at least 95% by mass of the solvent initially present, preferably of at least 97% by mass and more advantageously still of at least 99% by mass.

The concentration of block copolymer in the aqueous film-forming composition is, in the most general case, between 0.001 and 10% by mass with respect to the total mass on a dry basis of said composition.

In order to obtain optimum wetting of the support and to avoid the appearance of heterogeneities within the deposited layer produced, it is preferable to use a concentration of block copolymer of between 0.005 and 4% and more preferably still of between 0.01 and 1% by mass with respect to the total mass on a dry basis of said composition.

Such contents confer, on the aqueous composition, a viscosity suitable for application to the low-energy surface. Furthermore, these contents result in the production of a continuous film (without the appearance of dewetting regions) when they are applied using a film drawer to flat surfaces or, more generally, when the surface to be treated is immersed in said solution.

In addition, these concentrations are particularly well suited to carrying out, by simple drying, partial or complete removal of an aqueous solvent.

The drying is carried out, for example, at a temperature of between 15° C. and 50° C. (preferably between 19 and 25° C.) and under humidity conditions of between 10% and 70% and preferably between 50% and 60%. In the case where the deposited layer of the aqueous film-forming composition on the low-energy surface is produced using a film drawer, the film obtained has a thickness of between 10 and 100 microns and advantageously between 40 and 60 microns. Thus, the thickness of the film deposited can more advantageously still be of the order of 50 microns.

After the drying, a deposited layer of the aqueous film-forming composition is obtained with a thickness of between 10 nm and 1 μm, advantageously between 40 and 600 nm and preferably between 50 and 500 nm.

The term “aqueous film-forming composition” within the meaning of the invention is to be understood as any aqueous composition in the form of a dispersion or of a solution, generally in the form of a dispersion where the dispersed phase advantageously exhibits a size of between 10 Å and 100 μm, comprising:

as continuous or solvent phase, water, optionally in combination with other water-soluble compounds, such as alcohols and in particular ethanol; and

compounds of polymer or polymer precursor, acrylic resin or silicone type which are capable of resulting in the formation of a polymer film, of an acrylic film or of a silicone film following the application of the composition to a surface and following the at least partial evaporation of the water and optionally of the other water-soluble compounds, such as ethanol.

Thus, without implied limitation, the aqueous film-forming compositions of the invention can, for example, be compositions comprising an aqueous or aqueous/alcoholic dispersion of carbonaceous polymers in the form of a latex or of a formulation, of adhesive, mastic or paint type, for example, comprising such a latex, or of silicone precursors and in particular a mastic composition of the type of those disclosed in the documents EP 665 862, WO 98/13410 or WO 99/65973.

The block copolymers employed in the preparation of the deposited layer of the invention are preferably such that their hydrophilic block (h) is composed, at least in part, of monomer units selected from:

unsaturated ethylenic mono- and dicarboxylic acids, such as acrylic acid, methacrylic acid, itaconic acid, maleic acid or fumaric acid,

monoalkyl esters of the above unsaturated ethylenic dicarboxylic acids, preferably with C₁-C₄ alcohols, and their N-substituted derivatives, such as, for example, 2-hydroxyethyl acrylate or methacrylate,

amides of unsaturated carboxylic acids, such as acrylamide or methacrylamide, or

ethylenic monomers comprising a ureido group, such as ethylene urea ethyl methacrylamide or ethylene urea ethyl methacrylate, or

ethylenic monomers comprising at least one hydrogen phosphate or phosphonate group, such as vinylphosphonic acid or vinylidenephosphonic acid, or

phosphated acrylates or methacrylates of polyethylene glycol or phosphated acrylates or methacrylates of polypropylene glycol, or

ethylenic monomers comprising a sulfonic acid group or one of its alkali metal or ammonium salts, such as, for example, vinylsulfonic acid, vinylbenzenesulfonic acid, α-acrylamidomethyl-propanesulfonic acid or 2-sulfoethylene methacrylate, or

cationic monomers selected from aminoalkyl (meth)acrylates or aminoalkyl(meth)acrylamides;

monomers comprising at least one secondary, tertiary or quaternary amine functional group or a heterocyclic group comprising a nitrogen atom, vinylamine or ethyleneimine; diallyldialkyl-ammonium salts; these monomers being taken alone or as mixtures, and in the form of salts, the salts preferably being selected such that the counterion is a halide, such as, for example, a chloride, or a sulfate, a hydrosulfate, an alkyl sulfate (for example comprising 1 to 6 carbon atoms), a phosphate, a citrate, a formate or an acetate, such as dimethylaminoethyl (meth)-acrylate, dimethylaminopropyl (meth)acrylate, di(tert-butyl) aminoethyl (meth)acrylate, dimethyl-aminomethyl(meth)acrylamide or dimethylamino-propyl(meth)acrylamide; ethyleneimine, vinylamine, 2-vinylpyridine or 4-vinylpyridine; trimethyl-ammonium ethyl (meth)acrylate chloride, trimethylammonium ethyl acrylate methyl sulfate, benzyldimethylammonium ethyl (meth)acrylate chloride, 4-benzoylbenzyldimethylammonium ethyl acrylate chloride, trimethylammonium ethyl (meth)acrylamido chloride or (vinylbenzyl)-trimethylammonium chloride; diallyldimethyl-ammonium chloride, alone or as mixtures, or their corresponding salts, or

poly(vinyl alcohol), for example resulting from hydrolysis of a poly(vinyl acetate), or

cyclic amides of vinylamine, such as N-vinylpyrrolidone, or

a hydrophilic monomer originating from a chemical modification of a hydrophobic block, for example by hydrolysis of a poly(alkyl acrylate) to poly(acrylic acid).

Preferably, the monomer units present in the hydrophilic block (h) are chosen from acrylic acid (AA), 2-acrylamido-2-methylpropanesulfonic acid (AMPS), styrenesulfonate (SS), monomers comprising ureido group, monomers comprising phosphate or phosphonate group, or their mixtures.

More preferably still, use is made of acrylic acid (AA) units or of ethylenic monomers comprising ureido groups.

The hydrophobic block (H) of the block copolymers employed in the preparation of the deposited layer of the invention is preferably composed, at least in part, of monomer units selected from:

styrene-derived monomers, such as styrene, α-methylstyrene, para-methylstyrene or para-(tert-butyl)styrene, or

esters of acrylic acid or of methacrylic acid with optionally fluorinated C₁-C₁₂, preferably C₁-C₈, alcohols, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate,

vinyl nitriles comprising from 3 to 12 carbon atoms and in particular acrylonitrile or methacrylonitrile,

vinyl esters of carboxylic acids, such as vinyl acetate, vinyl versatate or vinyl propionate,

vinyl halides, for example vinyl chloride, and

diene monomers, for example butadiene or isoprene.

The monomer units present in the hydrophobic block (H) of the block copolymer employed in the preparation of the deposited layer of the invention are preferably esters of acrylic acid with linear or branched C₁-C₈ and in particular C₁-C₄ alcohols, such as, for example, methyl acrylate, ethyl acrylate, propyl acrylate, butyl acrylate or 2-ethylhexyl acrylate, or else styrene derivatives, such as styrene.

This hydrophobic block (H) can additionally comprise between 0 and 95% of hydrophilic monomers selected from the abovementioned list of hydrophilic monomers (h).

The block copolymers according to the invention can advantageously be diblock copolymers composed essentially of the combination of the two (h) and (H) blocks.

The block copolymers of the invention can also be triblock copolymers of formula (h)(H)(h′) or (H)(h)(H′), where (h′) represents a hydrophilic block which may or may not be the same as (h) and where (H′) represents a hydrophobic group which may or may not be the same as (H).

Mention may in particular be made, as block copolymers which are particularly advantageous in the context of the invention, of diblock copolymers based on a poly(acrylic acid) hydrophilic block and on a poly(butyl acrylate) hydrophobic block and especially of poly(acrylic acid)-poly(butyl acrylate) diblock copolymers, known as PAA-PbuA diblock copolymers.

These PAA-PbuA copolymers are characterized by an (acrylic acid)/(butyl acrylate) ratio by mass which can be between 10:90 and 90:10 and this ratio is preferably between 10:90 and 50:50.

Other block copolymers which are particularly advantageous in the context of the invention are, for example, block copolymers in which the hydrophilic block (h) is a poly(acrylic acid) and the hydrophobic block (H) is a random copolymer based on styrene and on acrylic acid comprising at least 25%, preferably 50% and more preferably still 75% by weight of acrylic acid with respect to the total weight of the blend. These copolymers are characterized by an (acrylic acid block)/(styrene block) ratio by mass which can be between 95:5 and 60:40 and this ratio is preferably between 85:15 and 95:5.

The amphiphilic block copolymers used in the invention generally exhibit a number-average molecular mass of between 1 000 and 100 000. Generally, their number-average molecular mass is between 2 000 and 60 000.

Whatever its precise chemical composition, the block copolymer employed in producing the deposited layer of the invention can advantageously be prepared according to a controlled radical polymerization process carried out in the presence of a control agent.

The term “controlled radical polymerization” is to be understood as a specific radical polymerization process, also denoted by the term of “living polymerization”, in which use is made of control agent such that the polymer chains being formed are functionalized by end groups capable of being able to be reactivated in the form of free radicals by virtue of reversible transfer and/or termination reactions.

Mention may in particular be made, as examples of such polymerization processes, of:

the processes of applications WO 98/58974, WO 00/75207 and WO 01/42312, which employ a radical polymerization controlled by control agents of xanthate type,

the process for radical polymerization controlled by control agents of dithioester type of application WO 97/01478,

the process of application WO 99/03894, which employs a polymerization in the presence of nitroxide precursors,

the process for radical polymerization controlled by control agents of dithiocarbamate type of application WO 99/31144,

the process for radical polymerization controlled by control agents of dithiophosphoroesters type of application PCT/FR01/02374,

the process of application WO 96/30421, which uses atom transfer radical polymerization (ATRP),

the process for radical polymerization controlled by control agents of iniferter type according to the teaching of Otu et al., Makromol. Chem. Rapid. Commun., 3, 127 (1982),

the process for radical polymerization controlled by degenerative transfer of iodine according to the teaching of Tatemoto et al., Jap. 50, 127, 991 (1975), Daikin Kogyo Co Ltd Japan, and Matyjaszewski et al., Macromolecules, 28, 2093 (1995),

the process for radical polymerization controlled by tetraphenylethane derivatives disclosed by D. Braun et al. in Macromol. Symp., 111, 63 (1996), or

the process for radical polymerization controlled by organocobalt complexes described by Wayland et al. in J. Am. Chem. Soc., 116, 7973 (1994).

Generally, it is preferable for the block copolymers employed according to the invention to result from a controlled radical polymerization process employing, as control agent, one or more compounds selected from dithioesters, thioethers-thiones, dithiocarbamates and xanthates. In a particularly advantageous way, the block copolymers used according to the invention result from a controlled radical polymerization carried out in the presence of control agents of xanthate type.

According to a preferred embodiment, the block copolymer used can be obtained according to one of the processes of applications WO 98/58974, WO 00/75207 or WO 01/42312, which employ a radical polymerization controlled by control agents of xanthate type, it being possible for said polymerization to be carried out in particular under bulk conditions, in a solvent or, preferably, in an aqueous emulsion, so as to directly obtain the copolymer in the form of an aqueous or aqueous/alcoholic solution, or easily applicable at a content of between 0.001 and 10% by mass. A solution of the copolymer at a content of between 0.001 and 10% by weight obtained directly by a polymerization process in the same organic solvent can also be used.

Thus, it is possible to employ a process comprising the following stages:

(a) a controlled radical polymerization is carried out, resulting in the production of a functionalized polymer of use as control agent in a controlled radical polymerization reaction, said stage being carried out by bringing into contact:

ethylenically unsaturated monomer molecules,

a source of free radicals, and

at least one control agent of formula (I):

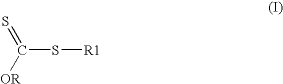

in which:

R represents:

H or Cl;

an alkyl, aryl, alkenyl or alkynyl group;

a saturated or unsaturated, optionally aromatic, carbonaceous ring;

a saturated or unsaturated, optionally aromatic, heterocycle;

an alkylthio group,

an alkoxycarbonyl, aryloxycarbonyl, carboxyl, acyloxy or carbamoyl group;

a cyano, dialkyl- or diarylphosphonato, or dialkyl- or diarylphosphinato group;

a polymer chain,

an (R2)O— or (R2)(R′2)N— group, in which the R2 and R′2 radicals, which are identical or different, each represent:

an alkyl, acyl, aryl, alkenyl or alkynyl group;

a saturated or unsaturated, optionally aromatic, carbonaceous ring; or

a saturated or unsaturated, optionally aromatic, heterocycle; and

R1 represents:

an alkyl, acyl, aryl, alkenyl or alkynyl group,

a saturated or unsaturated, optionally aromatic, carbonaceous ring;

a saturated or unsaturated, optionally aromatic, heterocycle; or

a polymer chain,

(b) following stage (a), a controlled radical polymerization stage or several successive controlled radical polymerization stages is/are carried out, said stage(s) each consisting in carrying out a controlled radical polymerization resulting in the production of a functionalized block copolymer of use as control agent in a controlled radical polymerization reaction, said stage or stages being carried out by bringing into contact:

ethylenically unsaturated monomer molecules other than those employed in the preceding stage,

a source of free radicals, and

the functionalized polymer resulting from the preceding stage.

It is understood that one of the polymerization stages (a) and (b) defined above results in the formation of the hydrophilic block (h) and that another of the polymerization stages of stages (a) and (b) results in the formation of the hydrophobic block (H). It should in particular be noted that the ethylenically unsaturated monomers employed in the stages (a) and (b) are selected from suitable monomers in order to obtain an amphiphilic block copolymer exhibiting the (h) and (H) blocks as defined above.

Thus, in the context of the formation of the hydrophobic block (H), the monomers employed can, for example, advantageously be esters of acrylic acid with linear or branched C₁-C₄ alcohols, such as, for example, methyl acrylate, ethyl acrylate, propyl acrylate or butyl acrylate, alone or as a mixture with other monomers, or else styrene as a mixture with at least 25% by weight of acrylic acid with respect to the total weight of the hydrophobic block (H).

The polymerization stages (a) and (b) are generally carried out in a solvent medium composed of water and/or of an organic solvent, such as tetrahydrofuran or a linear, cyclic or branched C₁-C₈ aliphatic alcohol, such as methanol, ethanol or cyclohexanol, or a diol, such as ethylene glycol.

An alcoholic solvent is more particularly recommended in the context of the use of hydrophilic monomers of the type of acrylic acid (AA), of acrylamide (AM), of 2-acrylamido-2-methylpropanesulfonic acid (AMPS) and of styrenesulfonate (SS) and/or in the context of the use of hydrophobic monomers, such as n-butyl acrylate, isobutyl acrylate, 2-ethylhexyl acrylate or t-butyl acrylate.

The coatings obtained by the application of the aqueous film-forming composition of the invention to a low-energy surface are generally such that they exhibit a strong cohesion between the surface and the coating produced.

Generally, the affinity of the coating for the low-energy surface is such that the 90° peel strength of this deposited layer at a peel rate of 300 mm/min, measurable, for example, using a dynamometer of Adamel-Lhomargy DY-30 type, is generally greater than or equal to 0.5 N/mm, advantageously greater than 1 N/mm, indeed even than 2 N/mm. In some cases, the peel strength can even be greater than 3 N/mm.

This strong affinity of the coating for the support is naturally reflected by very good stability of the coating on the surface.

In addition, the adhesion of the coating to the surface is not threatened in the presence of water.

Thus, even when the material is kept under 100% relative humidity conditions for a time of 72 hours, the 90° peel strength of the deposited layer generally remains greater than 0.5 N/mm and it is not rare for it to remain greater than 1 N/mm, indeed even than 2 N/mm, at a peel rate of 300 mm/min.

In the case of painted surfaces, the stability of the deposited layer can also be demonstrated by a test of resistance to wet abrasion, according to the DYN 53778 standard, which consists in rubbing the coating obtained with a brush of standardized hardness and standardized weight while dripping thereon water additivated with surfactant, which maintains the wetting of the surface, and in measuring the number of brushing cycle necessary to remove the coating over the whole of its thickness, so as to disclose the support.

The advantage of the use of the copolymers of the invention emerges clearly from the use of such tests, where it is found that the strength of an adhesive coating is greatly increased in the presence of these block copolymers.

The subject matter and the advantages of the present invention will become even more clearly apparent in the light of the various implementational examples set out below.

### EXAMPLE 1

### Preparation of a poly(butyl acrylate)-poly(acrylic acid) Diblock Copolymer According to the Invention, Characterized by a (butyl acrylate)/poly(acrylic acid) Ratio of 50:50 by Weight

The following mixture is introduced into a reactor equipped with a magnetic stirrer and with a reflux column and comprising 160 g of acetone:

3.04 g of O-ethyl dithiocarbonate (denoted-more simply by the term “xanthate” hereinafter),

21.24 g of isopropanol, and

0.82 g of azobisisobutyronitrile (AIBN).

The mixture was subsequently stirred and maintained at reflux at 70° C.

66 g of acrylic acid (AA) and 15 g of water were gradually added over 3 hours. 0.41 g of azobisisobutyronitrile were then added after adding for one hour and then a further 0.41 g of azobisisobutyronitrile were added after adding for a second hour.

Once the addition of acrylic acid is complete, the polymerization is allowed to continue for another hour. An amount of reaction mixture of 0.20 g is withdrawn as sample of PAA homopolymer.

The temperature is subsequently lowered to 65° C. by addition of 560 g of acetone.

140 g of butyl acrylate (BA) are added gradually over 3 hours while maintaining the temperature at 65° C. 0.40 g of AIBN is added at the beginning of the addition of BA. The reaction is allowed to continue for a further 3 hours. The reaction mixture is cooled and the solvents are virtually completely removed using a rotavapor (rotary evaporator). The residue obtained is dispersed in water and lyophilized. The polymer obtained is analyzed by carbon-13 nucleic magnetic resonance and by measuring its acid content.

The number-average molecular mass of the copolymer is 15 000.

The glass transition temperature of the hydrophobic block is −54° C.

The surface tension is 55 mN/m at 10⁻⁴ mol/l.

### EXAMPLE 2

### Preparation of a poly(butyl acrylate)-poly(acrylic acid) Diblock Copolymer According to the Invention, Characterized by a (butyl acrylate)/poly(acrylic acid) Ratio of 70:30 by Weight

The following mixture is introduced under a nitrogen atmosphere into a reactor equipped with a magnetic stirrer and with a reflux column and comprising 160 g of acetone:

0.61 g of xanthate,

4.25 g of isopropanol,

0.16 g of azobisisobutyronitrile.

The mixture thus obtained is placed under and maintained at reflux at 70° C. 13.2 g of acrylic acid (AA) and 30.3 g of water are gradually added over 3 hours. 0.08 g of azobisisobutyronitrile are then added after adding for one hour and then a further 0.08 g of azobisisobutyronitrile are added after adding for a second hour. Once the addition of acrylic acid is complete, the polymerization is allowed to continue for another hour. An amount of reaction mixture of 4.1 g is withdrawn as sample of PAA homopolymer.

The temperature is subsequently lowered to 65° C. by addition of 112 g of acetone. 28 g of butyl acrylate (BA) are gradually added over 3 hours while maintaining the temperature at 65° C. 0.08 g of AIBN is added at the beginning of the addition of BA. The nitrogen bleed is halted and the reaction is allowed to continue for a further 12 hours. The reaction mixture is cooled and the solvents are virtually completely removed using a rotavapor (rotary evaporator). The residue obtained is dispersed in water and lyophilized. The polymer obtained is analyzed by carbon-13 nuclear magnetic resonance and by measuring the acid content.

The number-average molecular mass is 15 000.

The glass transition temperature of the hydrophobic block is −54° C.

The surface tension is 52 mN/m at 10⁻⁴ mol/l.

### EXAMPLE 3

### Preparation of a poly(styrene-co-acrylic acid)-poly(acrylic acid) Diblock Copolymer According to the Invention, Characterized by a Hydrophobic Block of 2K and a Hydrophilic Block of 14K with a Variable Level of Acrylic Acid in the Hydrophobic Block (in Particular 73%)

### Synthesis of a Random Copolymer of Styrene, of Methacrylic Acid and of Ethyl Acrylate with Ratios by Mass: St/MAA/EtA=25/2/73

The polymerization is carried out under emulsion conditions in a jacketed reactor equipped with a three-bladed stainless steel stirrer. 875 g of water, 13.9 g of sodium dodecyl sulfate (Aldrich) and 0.31 g of sodium carbonate Na₂CO₃ are introduced at ambient temperature as vessel heel. The mixture obtained is stirred for 30 minutes (190 rev/min) under nitrogen. The stirring continues for an additional period of 55 minutes, during which the temperature is raised to 75° C., and then a mixture comprising 2.16 g of styrene, 9.01 g of methyl α-(O-ethylxanthyl)propionate (CH₃CHCO₂Me)SCSOEt, 0.17 g of methacrylic acid and 6.32 g of ethyl acrylate is incorporated. The temperature is subsequently raised to 85° C. and 1.58 g of ammonium persulfate (NH₄)₂S₂O₈ are added. After five minutes, the addition of 19.49 g of styrene, 1.56 g of methacrylic acid and 56.91 g of ethyl acrylate is continued for one hour. When the addition is complete, a polymer as an emulsion (latex) is obtained and is maintained at 85° C. for one hour.

197.29 g of the copolymer as an emulsion obtained above are withdrawn. 0.79 g of ammonium persulfate (NH₄)₂S₂O₈ and 3.5 g of water are added to it at 85° C. After five minutes, the addition is begun of a mixture composed of:

661.27 g of ethyl acrylate (EtA),

13.49 g of methacrylic acid (MAA),

and simultaneously another composed of:

420 g of water,

0.75 g of Na₂CO₃.

The addition lasts 1 hour. The system is maintained at this temperature for an additional three hours.

### 2) Hydrolysis of the Diblock Copolymer:

The hydrolysis is also carried out in a jacketed reactor equipped with a three-bladed stainless steel stirrer. The following are introduced therein:

54 g of the preceding copolymer (the solids content at 35.09%)

250.8 g of water (to adjust the solids content to 4%).

The temperature is brought to 85° C., during which the emulsion is vigorously stirred. 182 g of 2N sodium hydroxide (corresponding to two molar equivalents of sodium hydroxide with respect to the ethyl acrylate) are subsequently added thereto over two hours. After complete addition of the sodium hydroxide, the temperature is brought to 95° C. and the reaction is maintained under these conditions for 48 hours.

### EXAMPLE 4

Use of poly(butyl acrylate)-poly(acrylic acid) Diblock Copolymers According to the Invention as Additives in Aqueous Film-Forming Compositions in the Latex Form

The poly(butyl acrylate)-poly(acrylic acid) diblock copolymer obtained in examples 1 and 3 are employed in producing aqueous film-forming compositions according to the invention.

The latex used in this example is an industrial acrylic latex used in particular in decorative paint, sold by Rhodia under the reference DS 1003. It is an aqueous dispersion of particles of styrene-acrylate copolymers, the mean diameter of which is 150 nm, characterized by a content of polymers of 50% by mass with respect to th total mass of the aqueous composition.

In the various tests, one of the poly(butyl acrylate)-poly(acrylic acid) diblock copolymers obtained in examples 1 and 3 is added to this latex in variable amounts: 0.07%, 0.1% or 0.35% on a dry basis with respect to the weight of latex, also on a dry basis.

Coatings on various supports exhibiting flat low-energy surfaces are subsequently prepared starting from the compositions thus obtained.

In each of the tests, the surface of the support is cleaned beforehand with a rag impregnated with ethanol, so as to degrease it. After cleaning, each of the supports is placed in a climate-controlled chamber at 22° C. (±3° C.) and under relative humidity conditions of 55% (±5%) for 4 hours.

The characteristics of the supports are collated in table I below:

TABLE I

| | | Angle |
|---|---|---|
| | | formed by |
| | | a drop of |
| Support | Formula | water |
| Polyamide 6, 6 (Nylon-PA) | (—NH—CH₂)₆—NH—CO—(CH₂)₄—CO—) | 54° |
| Polycarbonates (PC) | (—O—CO—C—R—) | 77° |
| Poly (ethylene terephthalate) (PETP) | (—Ar—CO—O—(CH₂)₂—) | 79° |
| Poly (methyl methacrylate) (PMMA) | (—CH₂—CMe(COOCH₃)—) | 72° |
| Polypropylene (PP) | (—CH₂—CH(Me)—) | 102° |
| Polystyrene (PS) | (—CH₂—CH(Ar—)—) | 81° |
| Poly (vinyl chloride) (PVC) | (—CH₂—CHCl—) | 83° |
| ABS | Acrylonitrile-butadiene- | 74° |
| | styrene | |

A film with a uniform thickness of 50 microns is applied, using a film drawer, to the surface of the support thus conditioned starting from the test composition, which film is immediately covered with a strip of cloth with a width of 25 mm, intended to make it possible to subsequently carry out a 90° peel test on the coating obtained.

The film thus formed is subsequently allowed to dry in a climate-controlled chamber at 22° C. (±3° C.) and under relative humidity conditions of 55% (±5%) for 12 hours, so as to produce an adherent coating.

An accelerated aging of the coated support thus obtained is subsequently carried out by placing it in an oven at 40° C. and at 30% relative humidity for 12 hours.

The samples are subsequently placed in a climate-controlled chamber at 22° C. (±3° C.) and under relative humidity conditions of 55% (±5%) for 12 hours.

Following these various stages, a 90° peel test is carried out on the coating obtained, which test consists in pulling the strip of cloth attached to the coating in a direction perpendicular to the surface of the support until detachment of the coating and of the surface is obtained, over a length of 100 mm, the forces involved being measured using an Adamel-Lhomargy dynamometer of DY-30 type with a sensor of 100 N maximum. On conclusion of this test, a mean 90° tensile strength (T₉₀), expressed in N/mm, is determined which reflects the affinity of the coating produced with respect to the surface of the support and the stability of this coating.

The results obtained in the various tests carried out are collated in tables II to VII below:

TABLE II

| Nature of the | Nature of the copolymer present | T₉₀ |
|---|---|---|
| support | in the film-forming composition | (in N/mm) |
| PA | Copolymer of example 1 | 2.6 |
| | Concentration of 0.1% by mass | |
| | Copolymer of example 3 | 4.5 |
| | Concentration of 0.07% by mass | |
| | Copolymer of example 3 | 4.0 |
| | Concentration of 0.35% by mass | |
| | No copolymer as additive | 1.2 |
| | (control) | |

TABLE III

| Nature of the | Nature of the copolymer present | T₉₀ |
|---|---|---|
| support | in the film-forming composition | (in N/mm) |
| PC | Copolymer of example 1 | 2.1 |
| | Concentration of 0.1% by mass | |
| | Copolymer of example 3 | 5.5 |
| | Concentration of 0.07% by mass | |
| | Copolymer of example 3 | 3.0 |
| | Concentration of 0.35% by mass | |
| | No copolymer as additive | 1.2 |
| | (control) | |

TABLE IV

| Nature of the | Nature of the copolymer present | T₉₀ |
|---|---|---|
| support | in the film-forming composition | (in N/mm) |
| PETP | Copolymer of example 1 | 1.4 |
| | Concentration of 0.1% by mass | |
| | Copolymer of example 3 | 2.0 |
| | Concentration of 0.07% by mass | |
| | Copolymer of example 3 | 1.7 |
| | Concentration of 0.35% by mass | |
| | No copolymer as additive | 0.6 |
| | (control) | |

TABLE V

| Nature of the | Nature of the copolymer present | T₉₀ |
|---|---|---|
| support | in the film-forming composition | (in N/mm) |
| PMMA | Copolymer of example 1 | 2.4 |
| | Concentration of 0.1% by mass | |
| | Copolymer of example 3 | 2.2 |
| | Concentration of 0.07% by mass | |
| | Copolymer of example 3 | 2.0 |
| | Concentration of 0.35% by mass | |
| | No copolymer as additive | 1.3 |
| | (control) | |

TABLE VI

| Nature of the | Nature of the copolymer present | T₉₀ |
|---|---|---|
| support | in the film-forming composition | (in N/mm) |
| PS | Copolymer of example 1 | 2.2 |
| | Concentration of 0.1% by mass | |
| | Copolymer of example 3 | 2.5 |
| | Concentration of 0.07% by mass | |
| | Copolymer of example 3 | 4.2 |
| | Concentration of 0.35% by mass | |
| | No copolymer as additive | 1.3 |
| | (control) | |

TABLE VII

| Nature of the | Nature of the copolymer present | T₉₀ |
|---|---|---|
| support | in the film-forming composition | (in N/mm) |
| PVC | Copolymer of example 1 | 2.5 |
| | Concentration of 0.1% by mass | |
| | Copolymer of example 3 | 6.0 |
| | Concentration of 0.07% by mass | |
| | Copolymer of example 3 | 4.5 |
| | Concentration of 0.35% by mass | |
| | No copolymer as additive | 1.6 |
| | (control) | |

### EXAMPLE 5

### Use of the poly(butyl acrylate)-poly(acrylic acid) and poly(styrene-co-acrylic acid)-poly(acrylic acid) Diblock Copolymers of the Invention for Improving the Resistance to Wet Abrasion of a Paint Coating Deposited on a Thermoplastic Polymer Support: Simplified Formulation

The diblock copolymers of examples 1 and 3 are employed as additives for a latex participating in a paint formulation, a deposited layer of which is produced on a flat PVC support, black in color, reference Papier Lénéta.

The surface of the support employed is cleaned beforehand with a rag impregnated with ethanol, so as to carry out a degreasing. After cleaning, the support is placed in a climate-controlled chamber at 22° C. (±3° C.) and under relative humidity conditions of 55% (±5%) for 4 hours.

The latex DS1003 as defined in example 4 is subsequently treated with variable amounts (x=0.1% to 0.5% by mass with respect to the latex on a dry basis) as additives with the addition of sodium hydroxide until a pH of 8.5 is obtained.

A film with a thickness of 1.5 mm of a paint formulation is subsequently deposited on the cleaned surface using a film drawer, the paint formulation comprising:

100 parts by weight of calcium carbonate,

10 parts by weight of DS 1003 latex with the addition of x% of the diblock copolymer as an additive,

water, added so as to obtain a formulation having a solids content of 72% by mass.

The film obtained is subsequently allowed to dry in a climate-controlled chamber at 22° C. (±3° C.) and under relative humidity conditions of 55% (±5%) for 21 days.

Following these various stages, the coated support obtained is subjected to a test of resistance to wet abrasion (WAR) as defined in the DYN 53778 standard, which evaluates the resistance of the paint to washing and/or to detergent treatment.

It consists of the cyclic abrasion of a film of paint by a brush of standardized mass and standardized hardness while dripping a soap solution thereon. The WAR is expressed as the number of abrasion cycles which can be endured by the film before seeing the support appear: 100% of the paint has been removed.

The results of the WAR test are collated in table VIII below:

TABLE VIII

| Nature of the copolymer present in the film- | Level | |
|---|---|---|
| forming composition | (%) | WAR |
| No copolymer | 0 | 903 |
| Copolymer of example 1 | 0.1% | 963 |
| | 0.5% | 1 066 |
| Copolymer of example 2 | 0.1% | 930 |
| | 0.5% | 917 |

The increase in the number of wet abrasion cycles necessary during the addition of diblock copolymer within a certain concentration range clearly demonstrates the improvement in the cohesion between the support and the coating induced by the use of the block copolymer of the invention as additive in a latex participating in the composition of a simplified paint formula.

### EXAMPLE 6

### Use of the poly(butyl acrylate)-poly(acrylic acid) and poly(styrene-co-acrylic acid)-poly(acrylic acid) Diblock Copolymers of the Invention for Increasing the Resistance to Wet Abrasion of a Coat of Paint on a Support of Thermoplastic Polymer Type: Complete Formulation

The diblock copolymers of examples 1 and 3 are employed as additives for a latex participating in the formulation of a paint, a deposited layer of which is produced on a flat PVC support, black in color, reference Papier Lénéta.

The surface of the support employed is cleaned beforehand with a rag impregnated with ethanol, so as to carry out a degreasing. After cleaning, the support is placed in a climate-controlled chamber at 22° C. (±3° C.) and under relative humidity conditions of 55% (±5%) for 4 hours.

The latex DS1003 as defined in example 4 is subsequently treated with variable amounts (x=0.1% to 0.5% by mass with respect to the latex on a dry basis) [lacuna] as additives with the addition of sodium hydroxide until a pH of 8.5 is obtained.

A film with a thickness of 1.5 mm of a paint formulation is subsequently deposited on the cleaned surface using a film drawer, the paint formulation comprising:

100 parts by weight of a pigment base described below,

16 parts by weight of DS 1003 latex with the addition of x% of the diblock copolymer as an additive,

water, added so as to obtain a formulation having a solids content of 63.4% by mass.

The pigment base used is indicated in table IX below:

TABLE IX

| | | | Solids | Wet |
|---|---|---|---|---|
| | | | content | weight |
| Compound | | Density | (%) | (g) |
| Water | | | | 9 |
| Thylose MH 6000 | (thickener) | | 2 | 18.5 |
| XP (2%/H₂O) | | | | |
| Rhodoline DP 1130 | (dispersant) | | 40 | 0.35 |
| Proxel BD or GXL | (biocide) | | | 0.085 |
| Clerol TPE 714 | (antifoaming agent) | | 100 | 0.1 |
| TiO₂ RL 568 | (titanium dioxide) | 4 | 100 | 5 |
| Durcal 5 | (talc) | 2.7 | 100 | 30.45 |
| Omyalite 90 | (carbonate) | 2.7 | 100 | 20.02 |
| Clerol TPE 714 | (antifoaming agent) | | 100 | 0.1 |
| Pigment paste | | | | 83.785 |

The film obtained is subsequently allowed to dry in a climate-controlled chamber at 22° C. (±3° C.) and under relative humidity conditions of 55% (±5%) for 21 days.

Following these various stages, the coated support obtained is subjected to a test of resistance to wet abrasion (WAR) as defined in the DYN 53778 standard, which evaluates the resistance of the paint to washing and/or to detergent treatment.

It consists of the cyclic abrasion of a film of paint by a brush of standardized mass and standardized hardness while dripping a soap solution thereon. The WAR is expressed as the number of abrasion cycles which can be endured by the film before seeing the support appear: 100% of the paint has been removed.

The results of the WAR test are collated in table X below:

TABLE X

| Nature of the copolymer present in the film- | Level | |
|---|---|---|
| forming composition | (%) | WAR |
| No copolymer | 0 | 326 |
| Copolymer of example 1 | 0.1% | 339 |
| | 0.5% | 406 |
| Copolymer of example 2 | 0.1% | 406 |
| | 0.5% | 369 |

It is noted that, in the case of a complete formula paint, the resistance to wet abrasion is lower than in the case of a simplified formulation (lower number of cycles necessary for complete abrasion). However, there is [lacuna] increase in the number of cycles during the addition of diblock copolymer within a certain concentration range, which clearly demonstrates the improvement in the cohesion between the support and the coating induced by the use of the block copolymer of the invention as additive in the latex participating in the composition of a complete paint formula.

### EXAMPLE 7

### Use of the poly(butyl acrylate)-poly(acrylic acid) and poly(styrene-co-acrylic acid)-poly(acrylic acid) Diblock Copolymers According to the Invention for Improving the Effectiveness of the Deposition of a Paint on a Support of Thermoplastic Polymer Type

The diblock copolymer obtained in examples 1 and 3 are employed as additives for a latex participating in the formulation of a paint, a coat of which is deposited on a flat PVC support. By way of comparison, the paint formulated with an additive-free latex is also deposited on PVC.

The latex used in this example is an industrial acrylic latex used in particular in decorative paint, sold by Rhodia under the reference DS 1003. These characteristics are given in detail in example 4.

In each of the tests carried out, the surface of the support employed is cleaned beforehand with a rag impregnated with ethanol, so as to carry out a degreasing. After cleaning, each of the supports is placed in a climate-controlled chamber at 22° C. (±3° C.) and under relative humidity conditions of 55% (±5° C.) for 4 hours.

The latex DS1003 as defined in example 4 is subsequently treated with variable amounts (x=0.1% and 0.5% by mass with respect to the latex on-a dry basis) [lacuna] as additives with the addition of sodium hydroxide until a pH of 8.5 is obtained.

A film with a thickness of 1.5 mm of a paint formulation is subsequently deposited on the cleaned surface using a film drawer, this paint formulation comprising:

100 parts by weight of a pigment base described in example 6,

16 parts by weight of DS latex with x% of the diblock copolymer as additive,

water, added so as to obtain a formulation having a solids content of 63.4% by mass,

which film is immediately covered with a strip of cloth with a width of 25 mm intended to make it possible to subsequently carry out a 90° peel test on the coating obtained.

This film is subsequently allowed to dry in a climate-controlled chamber at 22° C. (±3° C.) and under relative humidity conditions of 55% (±5%) for 12 hours.

An accelerated aging of the coated support thus obtained is subsequently carried out by placing it in an oven at 40° C. and at 30% relative humidity for 12 hours.

The samples are subsequently placed in a climate-controlled chamber at 22° C. (±3° C.) and under relative humidity conditions of 55% (±50) for 12 hours.

A 90° peel test is then carried out on the coating obtained, which consists in pulling the strip of cloth attached to the coating in a direction perpendicular to the surface of the support at a rate of 300 mm/min until detachment of the coating and of the surface is obtained, over a length of 100 mm, the forces involved being measured using an Adamel-Lhomargy dynamometer of DY-30 type with a sensor of 100 N maximum. On conclusion of this test, a mean 90° tensile strength (Too), expressed in N/mm, which reflects the affinity of the coating produced with respect to the surface of the support and the stability of this coating, is determined.

The results obtained in the various tests carried out are collated in the following table XI:

TABLE XI

| Nature of the block copolymer and level | |
|---|---|
| as additive in the latex | T₉₀ (in N/mm) |
| No copolymer (control) | 0.5 |
| Copolymer of example 1 | 0.6 |
| at 66 ppm | |
| Copolymer of example 1 | 0.55 |
| at 330 ppm | |
| Copolymer of example 3 | 0.7 |
| at 66 ppm | |
| Copolymer of example 3 | 0.65 |
| at 330 ppm | |

This peel test makes it possible to show that the treatment of the latex with amphiphilic block copolymers as additives makes it possible to improve the adhesion of a coat of paint formulated with this latex to a plastic support of PVC type.

### EXAMPLE 8

### Use of the poly(butyl acrylate)-poly(acrylic acid) and poly(styrene-co-acrylic acid)-poly(acrylic acid) Diblock Copolymers According to the Invention for Improving the Effectiveness of the Deposition of a Paint on a Support of Thermoplastic Polymer Type in the Presence of Water

The diblock copolymer obtained in examples 1 and 3 are employed as additives for a latex participating in the formulation of a paint, a coat of which is deposited on a flat PVC support. By way of comparison, the paint formulated with an additive-free latex is also deposited on PVC.

The latex used in this example is an industrial acrylic latex used in particular in decorative paint, sold by Rhodia under the reference DS 1003. These characteristics are given in detail in example 4.

In each of the tests carried out, the surface of the support employed is cleaned beforehand with a rag impregnated with ethanol, so as to carry out a degreasing. After cleaning, each of the supports is placed in a climate-controlled chamber at 22° C. (±3° C.) and under relative humidity conditions of 55% (±5%) for 4 hours.

The latex DS1003 as defined in example 4 is subsequently treated with variable amounts (x=0.1% and 0.5% by mass with respect to the latex on a dry basis) [lacuna] as additives with the addition of sodium hydroxide until a pH of 8.5 is obtained.

A film with a thickness of 1.5 mm of a paint formulation is subsequently deposited on the cleaned surface using a film drawer, this paint formulation comprising:

100 parts by weight of a pigment base described in example 6,

16 parts by weight of DS 1003 latex with x% of the diblock copolymer as additive,

water, added so as to obtain a formulation having a solids content of 63.4% by mass,

which film is immediately covered with a strip of cloth with a width of 25 mm intended to make it possible to subsequently carry out a 90° peel test on the coating obtained.

This film is subsequently allowed to dry in a climate-controlled chamber at 22° C. (±3° C.) and under relative humidity conditions of 55% (±5%) for 12 hours.

An accelerated aging of the coated support thus obtained is subsequently carried out by placing it in an oven at 40° C. and at 30% relative humidity for 12 hours.

The samples are subsequently placed in a climate-controlled chamber at 22° C. (±3° C.) and under relative humidity conditions of 55% (±5%) for 12 hours.

The coated support are immersed for two consecutive hours in demineralized water and are then dried in a climate-controlled chamber at 22° C. (±3° C.) and under relative humidity conditions of 55% (±5%) for 24 hours.

On conclusion of this soaking/drying cycle, a 90° peel test is then carried out on the coating obtained, which consists in pulling the strip of cloth attached to the coating in a direction perpendicular to the surface of the support at a rate of 300 mm/min until detachment of the coating and of the surface is obtained, over a length of 100 mm, the forces involved being measured using an Adamel-Lhomargy dynamometer of DY-30 type with a sensor of 100 N maximum. On conclusion of this test, a mean 90° tensile strength (T₉₀), expressed in N/mm, which reflects the affinity of the coating produced with respect to the surface of the support and the stability of this coating, is determined.

The results obtained in the various tests carried out are collated in the following table XII:

TABLE XII

| Nature of the block copolymer and level | |
|---|---|
| as additive in the latex | T₉₀ (in N/mm) |
| No copolymer (control) | 0.6 |
| Copolymer of example 1 | 0.75 |
| at 66 ppm | |
| Copolymer of example 1 | 0.65 |
| at 330 ppm | |
| Copolymer of example 3 | 0.8 |
| at 66 ppm | |
| Copolymer of example 3 | 0.65 |
| at 330 ppm | |

This coating test makes it possible to show that the treatment of the latex with amphiphilic block copolymers as additives makes it possible to improve the adhesion of a coat of paint formulated with this latex to a plastic support of PVC type, this being the case even after prolonged immersion in water.

1. Use of an amphiphilic block copolymer comprising at least one block of hydrophobic nature and at least one block of hydrophilic nature, the block of hydrophobic nature exhibiting hydrophilic units in an amount of between 0% and 95% by weight with respect to the total weight of the units of the hydrophobic block, said copolymer optionally being dissolved in a solvent, such as an organic solvent, water or a water/alcohol mixture, as additive in an aqueous film-forming composition, for providing or promoting the adhesion of said composition to a low-energy surface.

2. The use as claimed in claim 1, characterized in that the low-energy surface is a surface exhibiting a contact angle of a drop of water deposited on the surface, corresponding to the angle which exists between the surface and the tangent to the drop at the surface/water/air interface, which is greater than 45°.

3. The use as claimed in either one of the preceding claims, characterized in that the low-energy surface is a surface based on a polyamide, on a polycarbonate, on a poly(ethylene terephthalate), on a poly(methyl methacrylate), on a polypropylene, on a polyethylene, on a polystyrene, on a polyester, on an acrylonitrile-butadiene-styrene (ABS) or on a poly(vinyl chloride).

4. The use as claimed in one of the preceding claims, characterized in that the block copolymer employed is such that its hydrophilic block (h) is composed, at least in part, of monomer units selected from:
unsaturated ethylenic mono- and dicarboxylic acids, such as acrylic acid, methacrylic acid, itaconic acid, maleic acid or fumaric acid,
monoalkyl esters of the above unsaturated ethylenic dicarboxylic acids, preferably with C₁-C₄ alcohols, and their N-substituted derivatives, such as, for example, 2-hydroxyethyl acrylate or methacrylate,
amides of unsaturated carboxylic acids, such as acrylamide or methacrylamide, or
ethylenic monomers comprising a ureido group, such as ethylene urea ethyl methacrylamide or ethylene urea ethyl methacrylate, or
ethylenic monomers comprising at least one hydrogen phosphate or phosphonate group, such as vinylphosphonic acid or vinylidenephosphonic acid, or
phosphated acrylates or methacrylates of polyethylene glycol or phosphated acrylates or methacrylates of polypropylene glycol, or
ethylenic monomers comprising a sulfonic acid group or one of its alkali metal or ammonium salts, such as, for example, vinylsulfonic acid, vinylbenzenesulfonic acid, α-acrylamiddmethyl-propanesulfonic acid or 2-sulfoethylene methacrylate, or
cationic monomers selected from aminoalkyl (meth)acrylates or aminoalkyl(meth)acrylamides; monomers comprising at least one secondary, tertiary or quaternary amine functional group or a heterocyclic group comprising a nitrogen atom, vinylamine or ethyleneimine; diallyldialkyl-ammonium salts; these monomers being taken alone or as mixtures, and in the form of salts, the salts preferably being selected such that the counterion is a halide, such as, for example, a chloride, or a sulfate, a hydrosulfate, an alkyl sulfate (for example comprising 1 to 6 carbon atoms), a phosphate, a citrate, a formate or an acetate, such as methylaminoethyl (meth)acrylate, dimethylaminopropyl (meth)acrylate, di(tert-butyl)aminoethyl (meth)acrylate, dimethyl-aminomethyl(meth)acrylamide or dimethylamino-propyl(meth)acrylamide; ethyleneimine, vinylamine, 2-vinylpyridine or 4-vinylpyridine; trimethyl-ammonium ethyl (meth)acrylate chloride, trimethylammonium ethyl acrylate methyl sulfate, benzyldimethylanmonium ethyl (meth)acrylate chloride, 4-benzoylbenzyldimethylammonium ethyl acrylate chloride, trimethylarmonium ethyl (meth)acrylamido chloride or (vinylbenzyl)-trimethylammonium chloride; diallyldimethyl-ammonium chloride, alone or as mixtures, or their corresponding salts, or
poly(vinyl alcohol), for example resulting from hydrolysis of a poly(vinyl acetate), or
cyclic amides of vinylamine, such as N-vinylpyrrolidone, or
a hydrophilic monomer originating from a chemical modification of a hydrophobic block, for example by hydrolysis of a poly(alkyl acrylate) to acrylic acid.

5. The use as claimed in claim 4, characterized in that the monomer units present in the hydrophilic block (h) of the block copolymer employed are acrylic acid (AA), 2-acrylamido-2-methylpropanesulfonic acid (AMPS) or styrenesulfonate (SS) units, monomers comprising ureido group, monomers comprising phosphate or phosphonate group, or their mixtures.

6. The use as claimed in one of the preceding claims, characterized in that the block copolymer employed is such that its hydrophobic block (H) is composed, at least in part, of monomer units selected from:
styrene-derived monomers, such as styrene, α-methylstyrene, para-methylstyrene or para-(tert-butyl)styrene, or
esters of acrylic acid or of methacrylic acid with optionally fluorinated C₁-C₁₂, preferably C₁-C₈, alcohols, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate,
vinyl nitriles comprising from 3 to 12 carbon atoms and in particular acrylonitrile or methacrylonitrile,
vinyl esters of carboxylic acids, such as vinyl acetate, vinyl versatate or vinyl propionate,
vinyl halides, for example vinyl chloride, and
diene monomers, for example butadiene or isoprene.

7. The use as claimed in claim 6, characterized in that the monomer units present in the hydrophobic block (H) of the block copolymer employed are esters of acrylic acid with linear or branched C₁-C₈ and in particular C₁-C₄ alcohols, such as, for example, methyl acrylate, ethyl acrylate, propyl acrylate, butyl acrylate or 2-ethylhexyl acrylate, or else styrene derivatives, such as styrene.

8. The use as claimed in one of the preceding claims, characterized in that the block copolymer employed is a poly(acrylic acid)-poly(butyl acrylate) diblock copolymer.

9. The use as claimed in claim 8, characterized in that the (acrylic acid)/(butyl acrylate) ratio by mass is between 10:90 and 90:10.

10. The use as claimed in any one of claims 1 to 7, characterized in that the block copolymer employed is a diblock copolymer in which the hydrophilic block (h) is a poly(acrylic acid) and the hydrophobic block (H) is a random copolymer based on styrene and on acrylic acid comprising at least 25%, preferably 50% and more preferably still 75% by weight of acrylic acid with respect to the total weight of the blend.

11. The use as claimed in claim 10, characterized in that the (acrylic acid block)/(styrene block) ratio by mass is between 95:5 and 60:40.

12. The use as claimed in one of the preceding claims, characterized in that the block copolymer employed is obtained on conclusion of a controlled radical polymerization process, preferably using, as control agent, one or more compounds selected from dithioesters, thioethers-thiones, dithiocarbamates and xanthates, said polymerization being carried out in particular under bulk conditions, in a solvent or in an aqueous emulsion, so as to directly obtain the copolymer in the form of an aqueous or aqueous/alcoholic solution.

13. The use as claimed in claim 12, characterized in that the concentration of block copolymer in the aqueous film-forming composition is between 0.001 and 10% by mass with respect to the total mass on a dry basis of the aqueous film-forming composition.

14. The use as claimed in claim 13, characterized in that the concentration of block copolymer in the aqueous film-forming composition is between 0.005 and 4% by mass with respect to the total mass on a dry basis of the aqueous film-forming composition.

15. The use as claimed in claim 14, characterized in that the concentration of block copolymer in the aqueous film-forming composition is between 0.01 and 1% by mass with respect to the total mass on a dry basis of the aqueous film-forming composition.

16. An aqueous film-forming composition comprising a block copolymer as defined in any one of claims 4 to 15.

17. The composition as claimed in claim 16, characterized in that the composition is an adhesive composition, a paint composition or a mastic composition, which may or may not comprise silicone.
